(19) United States
(12) Patent Application Publication
(10) Pub. No.: US 2017/0054792 A1
(43) Pub. Date: Feb. 23, 2017

(54) SYSTEMS AND METHODS FOR DEPLOYING APPLICATIONS

(71) Applicant: OTOY, INC., Los Angeles, CA (US)

(72) Inventors: Michael John Christopher, II, Los Angeles, CA (US); Nicholas Chadwick, Los Angeles, CA (US)

(21) Appl. No.: 14/549,066

(22) Filed: Nov. 20, 2014

(51) Int. Cl. H04L 29/08

(52) U.S. Cl. CPC H04L 67/10; H04L 67/32

(57) ABSTRACT

Systems and methods for remotely hosting applications are disclosed. A remote server receives files of a software application from an uploading user. An application package comprising a virtualized, self-sustaining executable of the software application is generated. An application id corresponding to the application package is provided to the uploading user who employs the application id to facilitate end user access to the software application hosted by the remote server. The remote server responds to the end user's request for access to the software application by transmitting the application package to a selected cloud server. The selected cloud server executes the application in the application packing within a corresponding virtualized environment and provides the end user, output from the software application executed in the virtualized environment.

### BACKGROUND

Rapid developments that occurred in the Internet, mobile data networks and miniaturization of client devices enabled users to carry out many personal or business tasks from almost any location that has data connectivity. Traditionally, software was almost exclusively available only via end user devices or client devices such as desktops or laptops that carry a robust operating system and have the software stored on local storage media such as hard drives or media discs. Such software was generally inaccessible from other machines unless stored on powerful, specialized servers that enabled remote access.

### SUMMARY

This disclosure relates to systems and methods for deploying software applications so that they are accessible by a variety of client devices from almost any global location that may have data connectivity. A method of hosting applications on remote servers is disclosed in accordance with some embodiments. The method comprises receiving, by a processor, application files of a software application provided by an uploading user and generating from the received application files, an application package for distribution via a plurality of cloud servers. In some embodiments, the application package comprises a self-sustaining executable file of the software application configured for execution in a virtual environment so that no changes are stored on an apparatus executing the application package when an end user exits an instance of the software application executed from the application package. An application identifier is provided to the uploading user, wherein the application identifier is configured for enabling end user access to the software application via a website when included into code of the website.

In some embodiments, the processor generates the application package by executing a clean server instance of a remote server, installing the application on the clean server instance and recording changes made to the clean server instance upon the installation of the application. The recorded changes are configured into a virtualized, self-sustaining executable file for distribution to the cloud servers upon request from an end user.

The method further comprises receiving, by the processor, a request for access to the software application from an end user. In some embodiments, the access request comprises the application identifier and the processor selects the application package from a plurality of application packages based on the application identifier in the access request. The processor further determines attributes of the access request received from the end user and selects one of the plurality of cloud servers to service the access request based on the attributes. The attributes determined from the access request can comprise geographic location of the client device and nature of the network employed by the client device for transmitting the access request. The processor additionally transmits the application package to a selected one of the plurality of cloud servers, in response to the access request from the end user. In some embodiments, the processor configures the application package to enable the end user's access to data files stored on a server of a third party cloud data storage service.

A computing device comprising a processor and a storage medium for tangibly storing thereon program logic for execution by the processor is disclosed in some embodiments. The programming logic comprises file receiving logic for receiving application files of a software application provided by an uploading user and generating logic that is executed by the processor to generate from the received application files, an application package for distribution via a plurality of cloud servers. The computing device further comprises, providing logic executed by the processor, for providing an application identifier to the uploading user, the application identifier is configured for enabling end user access to the software application via a website when included into code of the website.

In some embodiments, the generating logic further comprises, clean server executing logic, for executing a clean server instance of a remote server, installing logic, executed by the processor, for installing the application on the clean server instance and recording logic, executed by the processor, for recording changes made to the clean server instance upon the installation of the application. The generating logic further comprises change configuring logic and virtualizing logic, executed by the processor, for configuring the changes into the self-sustaining executable file and virtualizing the self-sustaining executable file for generating the software package.

Request receiving logic and determining logic, comprised in the non-transitory storage medium are executed by the processor, for receiving a request for access to the software application from an end user and for determining attributes of the access request received from the end user. In some embodiments, the access request comprises the application identifier and the computing device includes application selecting logic, executed by the processor, for selecting the application package from a plurality of application packages based on the application identifier in the access request. The computing device further comprises server selecting logic, executed by the processor, for selecting one of the plurality of cloud servers to service the access request based on the attributes. Transmitting logic, also comprised on the non-transitory storage medium is executed by the processor, for transmitting the application package to a selected one of the plurality of cloud servers, in response to the access request from the end user. In some embodiments, the computing device comprises configuring logic, executed by the processor, for configuring the application package to enable the end user's access to data files on a third party cloud storage.

Non-transitory computer readable storage medium comprising processor executable instructions for facilitating deployment of software applications on the cloud is disclosed in an embodiment. The computer readable storage medium comprises instructions for receiving application files of a software application provided by an uploading user and generating from the received application files, an application package for distribution via a plurality of cloud servers. The computer readable medium further comprises instructions for providing an application identifier to the uploading user wherein the application identifier is configured for enabling end user access to the software application via a website when included into code of the website. When a request for access to the software application from an end user is received, one of the plurality of cloud servers to service the access request is selected based on attributes of the request in accordance with the instructions on the computer readable storage medium. In some embodiments, the processor executable instructions further comprise instructions for transmitting the application package to a selected one of the plurality of cloud servers, in response to the access request from the end user. In some embodiments, non-transitory computer readable storage medium further comprises instructions for configuring the application package to enable the end user's access to data files on a third party cloud storage.

These and other embodiments will be apparent to those of ordinary skill in the art with reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 illustrates a remote access system that enables cloudifying software applications in accordance with some embodiments;

FIG. 2 is a block diagram that illustrates the details of a remote server in accordance with some embodiments;

FIG. 3 is a schematic diagram that shows the details of the distribution module in accordance with some embodiments;

FIG. 4 shows a schematic diagram of a cloud server in accordance with some embodiments described herein;

FIG. 5 is a flowchart detailing a method of deploying applications on the cloud in accordance with some embodiments;

FIG. 6 is a flowchart that details a method of producing an application package in accordance with embodiments detailed herein;

FIG. 7 is a flowchart that details the process of distributing an application on the cloud in accordance with embodiments described herein;

FIG. 8 is a flowchart that details a method of distributing an application to a requesting client device in accordance with embodiments described herein;

FIG. 9 is an illustration that shows an end user accessing the application via the cloud server in accordance with embodiments described herein.

FIGS. 10 A and 10B show the end user accessing data files hosted by a third party storage service via the application hosted by the cloud server in accordance with embodiments described herein;

FIG. 11 shows a schematic diagram of the browser window wherein an image file from a server associated with a third party data storage service is opened in an application executed by a cloud server;

FIG. 12 illustrates internal architecture of a computing device in accordance with embodiments described herein; and

FIG. 13 is a schematic diagram illustrating a client device implementation of a computing device in accordance with embodiments of the present disclosure.

### DESCRIPTION OF EMBODIMENTS

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

In the accompanying drawings, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

Embodiments are described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions or logic can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server. Servers may vary widely in configuration or capabilities, but generally a server may include one or more central processing units and memory. A server may also include one or more additional mass storage devices, one or more power supplies, one or more wired or wireless network interfaces, one or more input/output interfaces, or one or more operating systems, such as Windows Server, Mac OS X, Unix, Linux, FreeBSD, or the like.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network. Various types of devices may, for example, be made available to provide an interoperable capability for differing architectures or protocols. As one illustrative example, a router may provide a link between otherwise separate and independent LANs.

A communication link may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links, such as may be known to those skilled in the art. Furthermore, a computing device or other related electronic devices may be remotely coupled to a network, such as via a telephone line or link, for example.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part. In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The advent of the mobile data networks and smaller client devices such as tablets and smartphones has created an opportunity for user data and software to be accessible from remote locations. Various software “apps” are now available on mobile devices enabling different personal and business functions for end users. The smaller size of mobile devices such as smartphones and tablets which makes them portable also limits the amount of data they can carry on board. Portable storage devices such as flash drives provide one solution to this problem. Another solution is to store the data and software applications on collections of servers that make up the ‘cloud’.

A computing device located anywhere on the globe with data connectivity when properly authenticated can securely access data and software on the cloud. Many software applications are however, developed for use on personal computing devices such as desktops and laptops. Such software applications need to be re-configured for storage to the cloud and to enable users to access them from their cloud storage. Re-configuring a software application that was originally designed for a personal computing device such as a desktop to execute from a remote storage location can be expensive. Moreover, establishing and maintaining the infrastructure necessary for storing applications on the cloud can be a task beyond the capabilities of small software vendors. Systems and methods are disclosed herein for deploying applications developed for personal computing devices to the cloud. Once installed on the cloud, developers can provide access by streaming such ‘cloudified’ applications to their end users.

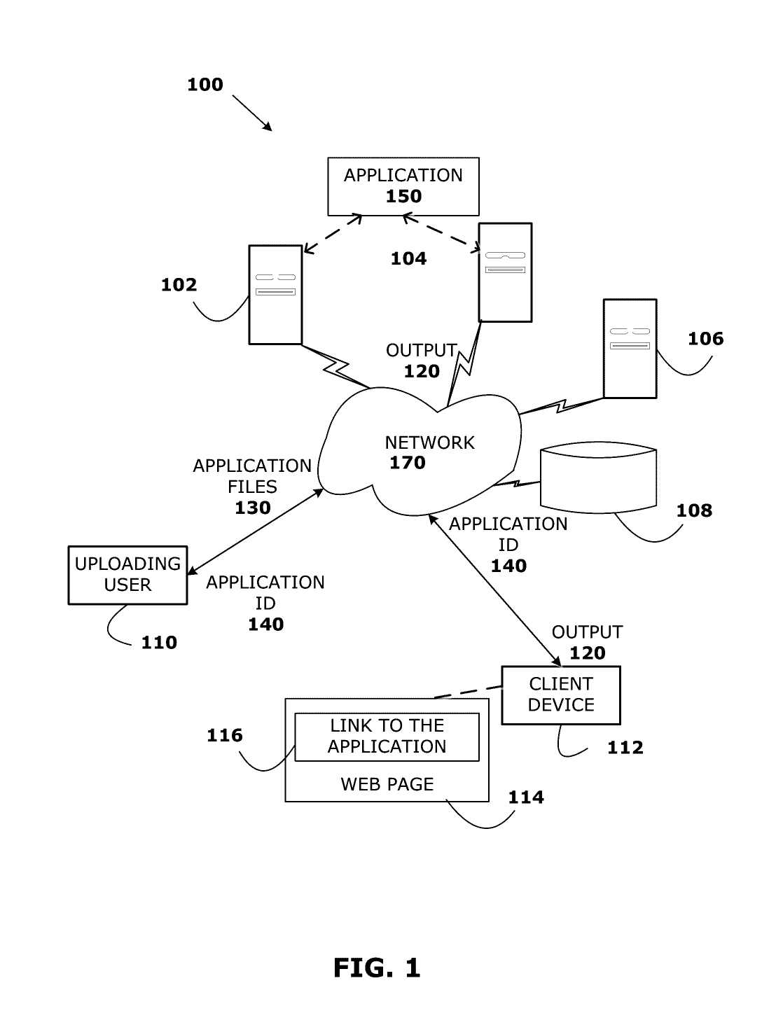

FIG. 1 illustrates a remote access system 100 that enables cloudifying software applications wherein a software application 150 is deployed on a remote server 102 in accordance with some embodiments. The application 150 is uploaded by an uploading user such as for example, a developer 110 of the application 150. In some embodiments, the remote server 102 is not controlled by the developer 110 of the application 150. Rather, the remote server 102 is configured to deploy applications received from uploading users and facilitate end users to access and interact with such uploaded applications such as, the application 150. Communication network 170 such as the Internet can be employed by the uploading users such as the developer 110 to provide their application files 130 for deployment to the remote server 102. Similarly, end users can access the uploaded applications such as the application 150, through the communication network 170 using their client device(s) 112. In some embodiments, the developer 110 can be any entity that controls access rights to the application 150. The entity may be without limitation, an individual or a corporation that developed the application 150 and allows their end users to purchase the application 150.

In some embodiments, when the developer 110 uploads the application files 130, they are further configured by the remote server 102 for deployment to the ‘cloud’. The application files 130 can comprise without limitation, configuration files, data files, DLLs (dynamic linked libraries), Active X control files and the like that are required for proper execution of the application 150. Upon receiving the application files 130, the remote server 102 generates an application ID 140. The application ID 140 is provided to the developer 110 for including in a user interface such as a webpage 114 via which the developer 110 provides end users access to the application 150. In some embodiments, the application ID 140 can be included as a link 116 which can be selected by an end user in order to access the application 150. The link 116 is configured such that when the end user clicks on the link 116, the application ID 140 is passed to the remote server 102, for example, within the HTTP (Hypertext Transfer Protocol) request.

When the remote server 102 receives the request initially determines the attributes of the request from the client device 112. The attributes can include but are not limited to, the application ID 140, the type of client device 112 making the request, the location of the client device 112 and the application 150 for which access is requested. Based on such attributes, the application 150 or a particular application package as detailed further infra can be selected from a plurality of applications and/or application packages hosted by the remote server 102. In some embodiments, the plurality of application packages can be associated with different applications. In some embodiments, multiples ones of the plurality of application packages can be associated with the same application 150. For example, different versions of the application can be associated with different application packages. Accordingly, the application ID 140 supplied in the request can be associated with a particular application package of the plurality of application packages that may be associated with the application 150.

In addition, the remoter server 102 further selects the cloud server 104 based on the attributes of the received request and the application 150 (or a selected application package) is loaded to the selected cloud server 104. In some embodiments, the cloud server 104 sets up a secure, virtual session with the client device 112. The communication session can be secured via protocols such as SSL (Secure Socket Layer). When the tunnel is established, the selected cloud server 104 executes the application 150 and streams the output of the application 150 to the client device 112 via the secure tunnel. The end user can interact with the application 150 as if it were being executed on the client device 112.

In some embodiments, the application 150 can also be configured to access the end user's data files from one or more of a local storage of the client device 112 or the third-party cloud storage or third-party cloud storage server 108. In some embodiments, the third-party cloud storage drive is not associated with either the developer 110 or the remote server 102. In this case, the secure tunnel can be setup between the cloud server 104, the client device 112 and optionally the third party cloud storage server 108. For example, if the application 150 is a word processing application, the end user can employ the instance of the application 150 executed by the cloud server 104 and streamed to the client device 112 to access and interact with text files stored on the third party cloud storage server 108. Upon editing the text files, the user may choose to store the edited files either to the third party cloud storage 108 or to a local storage medium within the client device 112. The selected cloud server 104 executes the application 150 and streams the output 120 to the client device 112 through the secure tunnel. When the end user exits the application 150, the tunnels are shut down and the virtual session is destroyed thereby removing all traces of any data that existed during the session. Hence, no data regarding the communication session is left on the client device 112 for other users to access.

It may be appreciated that while the uploading user/developer 110 and the end user are illustrated as different entities in FIG. 1, this is not necessary. In some embodiments, the uploading user can also be an end user (not show) who purchased the application 150 from a vendor. The end user who purchased the application 150 from a vendor may upload it to the remote server 102. Instead of being constrained to access the application 150 only on a device on which the application 150 is installed, the end user can now access the application 150 from any location having data connectivity and from almost any computing device without limitation to hardware or software configuration. The remote access system 100 therefore enables cloudifying software applications for developers and end users alike.

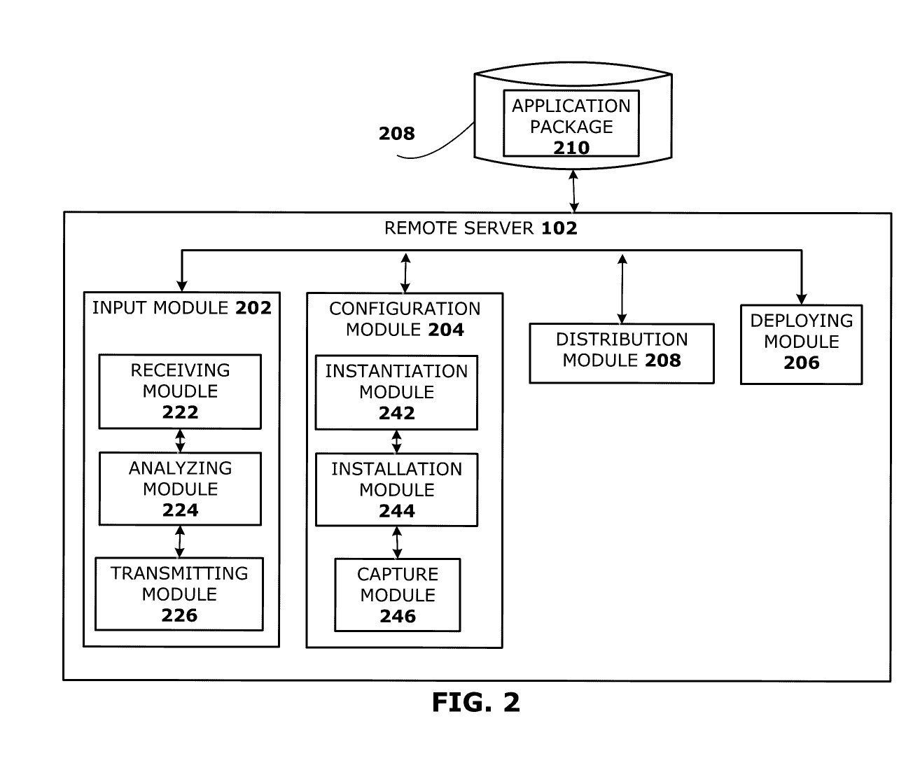

FIG. 2 is a block diagram that illustrates the details of the remote server 102 in accordance with some embodiments. The remote server 102 comprises an input module 202 for receiving various requests. In some embodiments, the receiving module 222 of the input module 202 receives a variety of requests from users wanting to upload applications for distribution via the cloud servers 104, 106 and also from end users wanting to access applications on the cloud. Accordingly, the analyzing module 224 analyzes the various requests to determine if the request was received from an uploading user or an end user. A request received from an uploading user wanting to deploy application(s) on the cloud will have different attributes that the request from an end user or a downloading user who wishes to access an application currently deployed on the cloud. By the way of illustration and not limitation, the request from an end user may be received from a webpage or other interface associated with a currently deployed application and can include an application ID associated with a particular application. On the other hand, the request from an uploading user may be directed towards uploading application files for deployment and distribution via the cloud servers. Hence, the analyzing module 224 determines the type of request received based on the various request attributes. Based on the determination from the analyzing module 204, the transmission module 226 transmits the received request to one or more of the configuration module 204 or the distribution module 208.

In some embodiments, when it is determined that a request for deploying the application 150 is received from the developer 110, the transmission module 226 communicates the request to the configuration module 204 for configuring the remote server 204 to receive the application files 130 from the developer 110. In some embodiments, the instantiation module 242 comprised in the configuration module 204 launches a clean server instance for installing the application 150 on the remote server 102. In some embodiments, the clean server instance is a virtual instance of the remote server 102 without any changes to its original status. For example, if the operating system executing on the remote server 102 is a WINDOWS SERVER, the file system registry of the clean server instance has a default neutral state. The clean server instance is a configuration of the remote server 102 without any changes to the original files or registries and hence the clean server instance has no other software installed thereon. Upon launching the clean server instance, the installation module 244 signals the developer 110 to install the application 150 on the clean server instance. In some embodiments, views of the installation process can be provided by the installation module 244 so that the developer 110 can monitor the installation process. Upon completion of the installation process, the configuration module 204 stores the application files to a database 208. The application ID 140 is provided to the developer 110 who can then use it to enable end-user access to the application 150.

The configuration module 204 comprises a capture module 246 in order to capture the differences caused by installation of the application 150 on the clean server instance. By the way of illustration and not limitation the changes effected to the files, registries of the clean server and the services installed on the clean server instance are recorded by the capture module 246. The configuration module 204 therefore obtains the delta of the state of the remote server 102 in production prior to the installation of the application 150 and the state of the remote server 102 after the installation of the application 150. Utilities such as but not limited to, the BoxedApp Packer can be used for converting regular, full-fledged applications into application packages as described herein. The changes obtained by the capture module 246 are transmitted to the deploying module 206 which generates an application package 210 for access by the end users. In some embodiments, the deploying module 206 thus converts the application files 130 supplied by the developer 112 into a single self-sustaining executable that does not require installation in order to be run.

In some embodiments, when it is determined by the analyzing module 224, that a request for access to the application 150 currently accessible via the remote access system 100, is received, it is forwarded to the distribution module 208. For example, if the request was received from a webpage or a UI associated with the application 150 and the request comprises the application ID 140, it can be determined that the request was from an end user and accordingly, the transmission module 226 forwards the request to the distribution module 208. The distribution module 208 selects one of the cloud servers 104, 106 for servicing the request and provides the application package 210 to a selected cloud server for streaming the output to the client device 112 in accordance with embodiments detailed further herein. It may be appreciated that uploading of a single application 150 is described herein for simplicity and that the remote server 102 may simultaneously execute a plurality of clean server instances while multiple uploading users install a plurality of applications for deployment on the cloud.

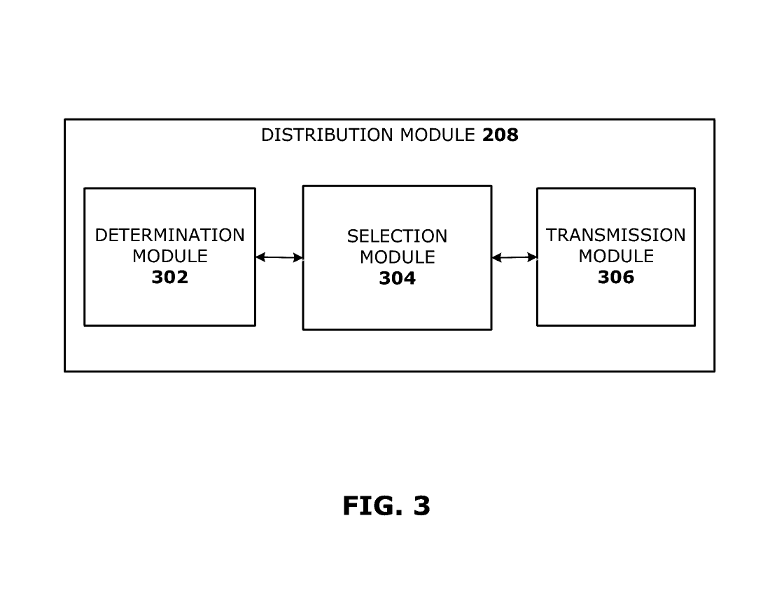

FIG. 3 is a schematic diagram that shows the details of the distribution module 208 in accordance with some embodiments. The distribution module 208 comprises a determination module 302, a selection module 304 and a transmission module 306. The determination module 302 comprises instructions or programming logic for determining the attributes of the request from the client device 112. For example, attributes of the request such as but not limited to, the application ID 140, an IP address or location coordinates associated with the request, the specification of the device 112 making the request, the nature of the network (wired, wireless, mobile, 3G or 4G) employed by the device 112 to make the request can be obtained.

The attributes thus determined enable the selection module 304 to retrieve the application package 210 from the storage 208. As described supra, the application package 210 can be a self-sustaining executable that does not require any installation. The selection module 304 further selects one of the cloud servers 104 or 106 for servicing the request. For example, based on one or more of the IP address/location information of the request and the capacity of the cloud servers, the selection module 304 may select the cloud server 104 for servicing the request. The selected application package 210 is transmitted along with information regarding the requesting client device 112 to the selected cloud server 104 by the transmission module 306. The information regarding the client device 112 can include the IP address of the client device 112 and software and hardware attributes of the client device 112 that can be employed by the selected cloud server 104 to stream the output of the executed application. The output can be streamed to the client device 112 via various methodologies currently known in the art. By the way of illustration and not limitation, browser-based scripts such as, HTML or Java script can be used to transmit the output of the application 150 from the cloud server 104 to the client device 112 and to receive user interactions with the application 150 executing on the cloud server 104. Thus, the cloud server 104 can provide access to applications via a variety of device regardless of their hardware and/or software platforms as most client devices have the ability to interpret browser-based code.

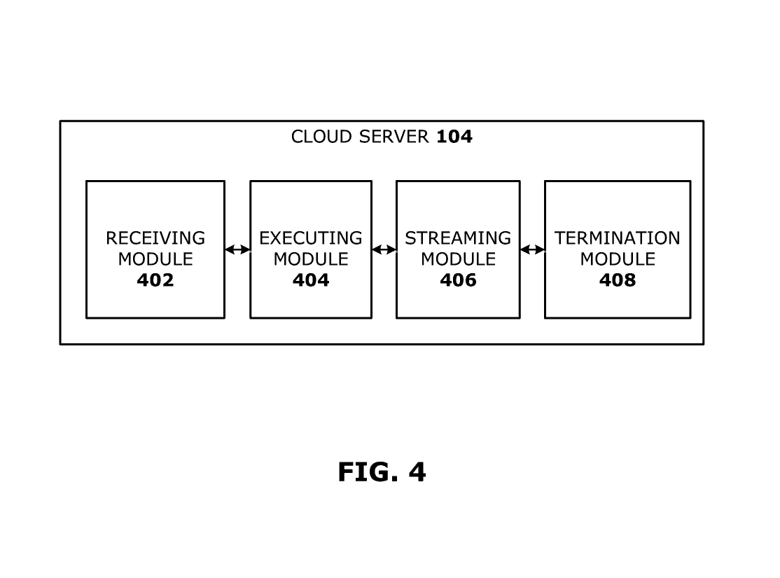

FIG. 4 shows a schematic diagram of a cloud server 104 in accordance with some embodiments described herein. The cloud server 104 comprises a receiving module 402, an executing module 404, a streaming module 406 and a termination module 408. The receiving module 402 receives the selected application package 210 from the remote server 102. The receiving module 402 can be configured to further receive information regarding the client device 112 that requested access to the application 150.

The executing module 404 further executes the received application package 210. In some embodiments the application package 210 packages an executable file of the application 150 with a virtual environment program. When the application package 150 is executed, by the cloud server 104, it creates a virtual environment and loads the executable of the application 150 into the virtual environment. Thus, the application 150 is “sandboxed” or “containerized” in the virtual environment wherein the hardware of the cloud server 104 emulates a file system and system registry for the application 150 so that virtual files are created and registry entries are spoofed or faked.

In some embodiments, the streaming module 406 can be configured to establish a secure communication channel with the client device 112. The output of the application 150 is transmitted to the client device 112 via the secure communication channel. In addition, user interaction with the application 150 being executed by the cloud server 104 is also received on the secure communication channel. The user employing the client device 112 will be able to interact with the application 150 as if it was executing locally on the client device 112. In addition, based on the user request, the cloud server 104 can be further configured to open other secure communication channel(s) with one or more third party cloud storage(s) 108. The user can access information such as but not limited to, data files on the cloud storage 108 via the application 150 executing on the cloud server 104.

In some embodiments, the user can store the data files acted upon by the application in one or more of the cloud storage or a local storage medium of the client device 112. Upon completion the user interaction, the user can exit the application securely. Accordingly, the termination module 408 closes the communication channel(s) and removes all traces of any data that existed during the session. This ensures that no residual data is left for access by other users. Hence, the remote server 102 enables users to securely access applications on the cloud from any location on the globe that has data connectivity and using devices other than which the application 150 may have been specifically configured for.

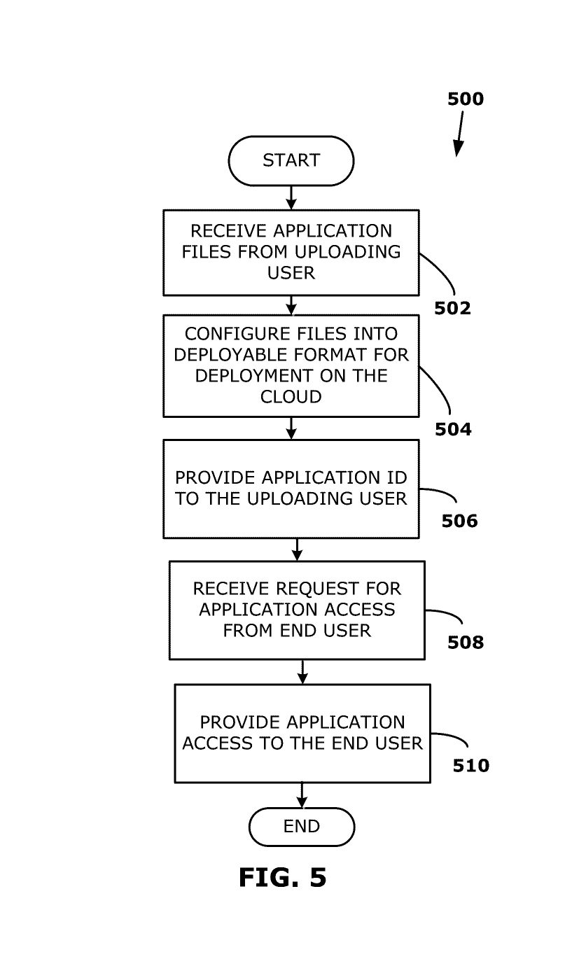

FIG. 5 is a flowchart 500 detailing a method of deploying applications on the cloud in accordance with some embodiments. The method begins at 502 with receiving application files 130 from an uploading user such as the uploading user 110 of the application 150. At 504, the received application files 130 are configured into a format for deploying on the cloud. As described supra, the executable of the application 150 is configured to execute in a virtual environment. For example, developer libraries such as but not limited to, BoxedApp SDK from Softanics can be used for application virtualization. At 506, an application ID 140 is provided to the uploading user 110 for providing access to the application 150 via other user interfaces such as webpages. When a request for access to the application 150 is received from an end user at 508, the application 150 is made available to the end user at 510 in accordance with embodiments described herein.

In some embodiments, the application ID 140 can be a 128-bit UUID (a Universally Unique Identifier) which identifies specific executables in the storage 208. In some embodiments, a link to the application package 210 on the storage 208 is further transmitted to the developer 110 for including in a website providing access to the application 150. This can enable the developer to provide access to multiple versions of the application 150 via multiple links corresponding to the various application packages that include different versions. In some embodiments, an updateable link to a default version of the application 150 can also be provided to the developer 110 which may enable end-user access to the default version of the application.

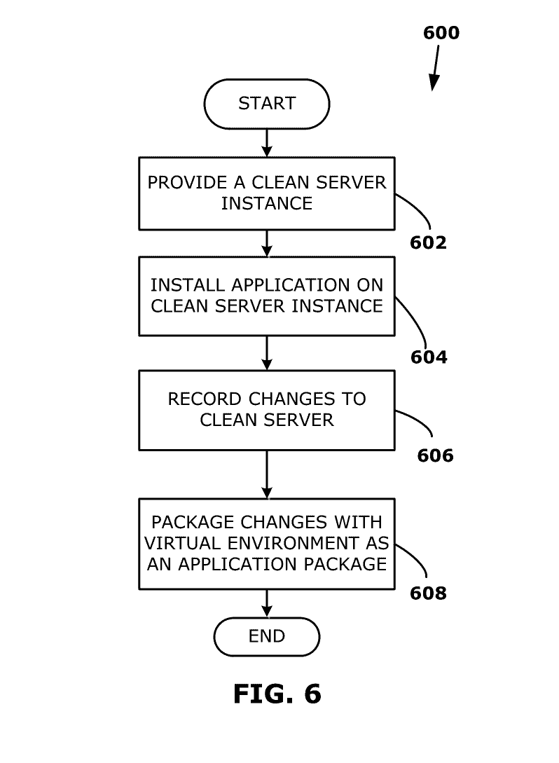

FIG. 6 is a flowchart 600 that details a method of producing an application package in accordance with embodiments detailed herein. The method commences at 602 wherein a clean server instance is launched upon receiving a request to upload an application from an uploading user 110. As detailed herein, the clean server instance matches settings of the remote server 102 in a default, neutral state. At 604, the application 150 provided by the uploading user 110 is installed on the clean server instance. The changes made to the clean server instance by the installation of the application 150 are recorded at 606. The changes recorded at 606 are virtualized and packaged at 608 into a deployable format that comprises a single, self-sustaining executable that does not require any installation in order to run. By the way of illustration and not limitation, BoxedApp Packer utility can be used to convert the recorded changes to a single executable which can be virtualized using BoxedApp SDK library. Other methodologies of producing single, self-sustaining executable files and other technologies of application virtualization now know or to become known can also be employed in accordance with embodiments described herein. When a request for access to the application 150 is received from an end user, the deployable format is distributed for end-user access in accordance with embodiments described herein.

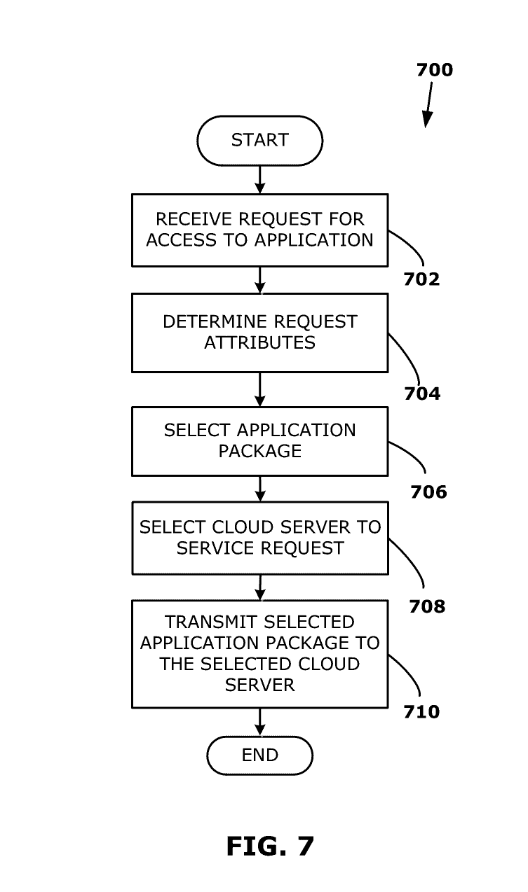

FIG. 7 is a flowchart 700 that details the process of distributing an application on the cloud in accordance with embodiments described herein. When a request for access to the application 150 is received at 702 from a client device 112, the request is analyzed in order to determine its attributes at 704. In some embodiments, the application ID 140 is included by the uploading user 110 in a webpage that is employed by an end user to request access. Hence, the request can comprise the application ID 140 which identifies the particular application package 210. In addition, attributes such as but not limited to, the client device 112 making the request, the hardware/software associated with the client device 112, the nature of the network employed by the client device 112 for transmitting the request and the geographic location of the client device 112 can also be determined.

For example, the identity of the client device 112 can be obtained from the HTTP request header when a browser is employed to send the request. The hardware/software attributes of the client device 112 can be obtained from a pre-existing database of various client devices and their related information. The geographic location of the client device 112 can be obtained from the GPS coordinates if they are available or from the originating IP address. The network information, such as, whether the transmitting network is a wired, wireless, mobile network and the type of mobile network can also be obtained, for example, from the request.

Based on the application ID 140, the application package 210 is selected at 706. The various attributes are further used for identifying and selecting the cloud server 104 from a plurality of cloud servers 104, 106 to service the request at 708. One or more of the factors such as but not limited to, availability of the servers 104, 106, the nature of the network used by the client device 112, the load on the servers 104, 106 and the geographic location of the client device 112 can be employed for the server selection. The application package 210 is transmitted to the selected cloud server 104 at 710 for enabling end user access to the application 150.

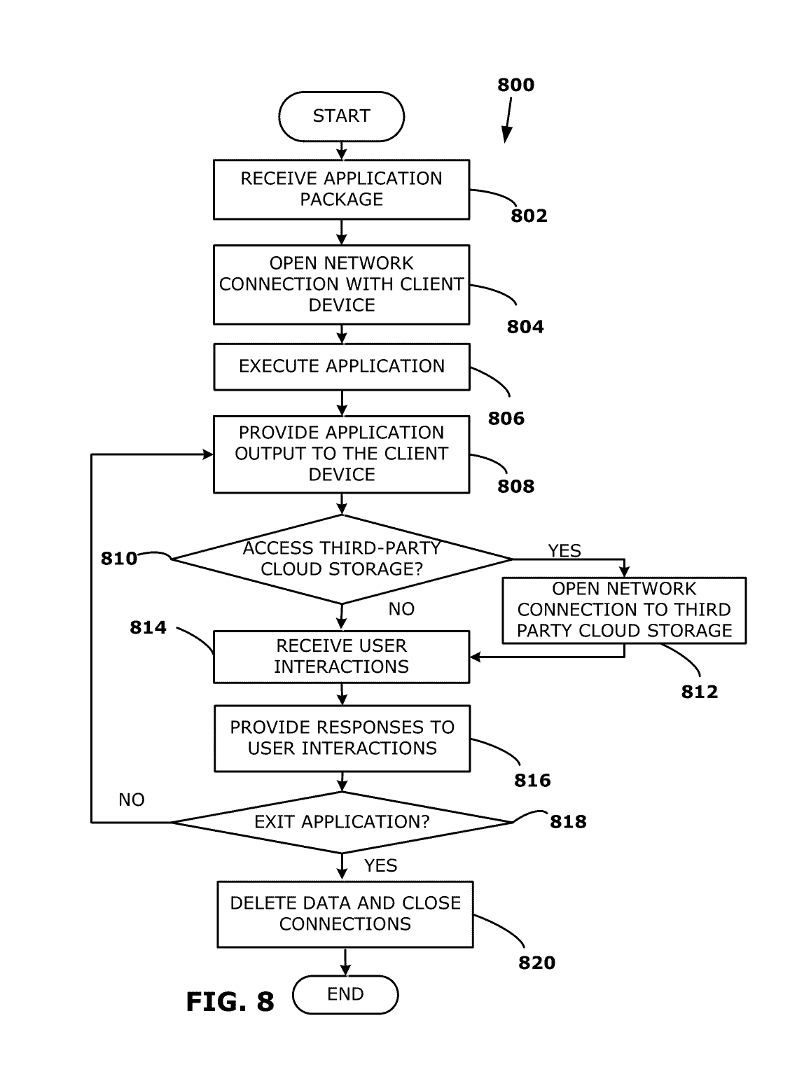

FIG. 8 is a flowchart 800 that details a method of distributing an application 150 to a requesting client device 112 in accordance with embodiments described herein. The method begins at 802 wherein a selected cloud server 104 receives the application package 210 identified in the access request. In addition, the cloud server 104 can also receive information related to the requesting client device 112 thereby enabling it to provide access to the application 150. At 804, the cloud server 104 opens a secure network connection with the client device 112. Various security mechanisms such as but not limited to Secure Socket Layer (SSL), can be used to secure the communication channel or connection between the cloud server 104 and the client device 112.

The received application package 210 is executed at 806. In some embodiments, the application package 210 comprises a single, self-sustaining executable file that is run in a virtualized environment. The cloud server 104 therefore, provides virtual conditions such as the keys, registry entries, values and virtual files that simulate the actual environment in which the application executable is run. Simulating a virtual environment enables the application 150 to run properly even when it does not have access to the registry and file system of the cloud server 104. Virtualization also helps if the application 150 has files for example, DLLs (Dynamic Linked Libraries), that need to be secured and hence may not be saved to the local drive of an executing device 104. Moreover, virtualizing an execution environment for the application 150 also helps when the application 150 run without installation even when it comprises Active X controls which need an installer for their execution.

At 808, the output obtained from the execution of the application is provided or streamed to the client device 112. By the way of illustration and not limitation, the output from the application 150 can be provided via browser-based HTML (Hyper Text Markup Language) or Java script. In some embodiments, when the user interface of the application 150 is streamed to the client device 112, an input may be received from the user for accessing data files. For example, if the application 150 is a graphics processing program, the end user may select a menu item to open a data file. Accordingly, it is determined at 810 if any further connections or communication channels need to be opened. For example, the data file the end user desires to open may be locally stored on the client device 112. In this case, it is determined at 810 that no further connections are needed and hence further user interactions are received at 814. On the other hand, the menu item to open the file may enable the end user to access data files stored on external, third-party cloud storages which may or may not be associated either with the developer 110 or with the remote server 102.

For example, if the end user so desires, access to data files on DROPBOX, GOOGLE DRIVE and other cloud storage services can be facilitated via opening a new connection or communication channel between the cloud server 104 and the third-party storage drive 108 at 812. Further general user interactions such as but not limited to, creating new files, opening, closing, editing, saving and deleting files, updating settings, or other application-specific interactions of the end user with the application 150 being executed by the cloud server 104 are received at 814. The appropriate responses to the user interactions received at 814 are provided at 816. In some embodiments, the user interactions received at 814 may signal that the end user desires to quit the application 150, if such a user input is detected at 818, the instance of the application 150 is killed, the data related to the session is deleted at 820. Else application execution and user interaction continues until the user's input to exit the application or other input such as timeout due to inactivity are received at 818. In response to such input to exit the instance of the application 150, the various network connections between one or more of the client device 112, the cloud server 104 and the third-party storage 108 are closed at 820. The procedures executed at 820 ensure that there is no residual data related to the session on any of the devices including the client device 112 and the cloud server 104 which may be accessed by other users after the communication session has ended.

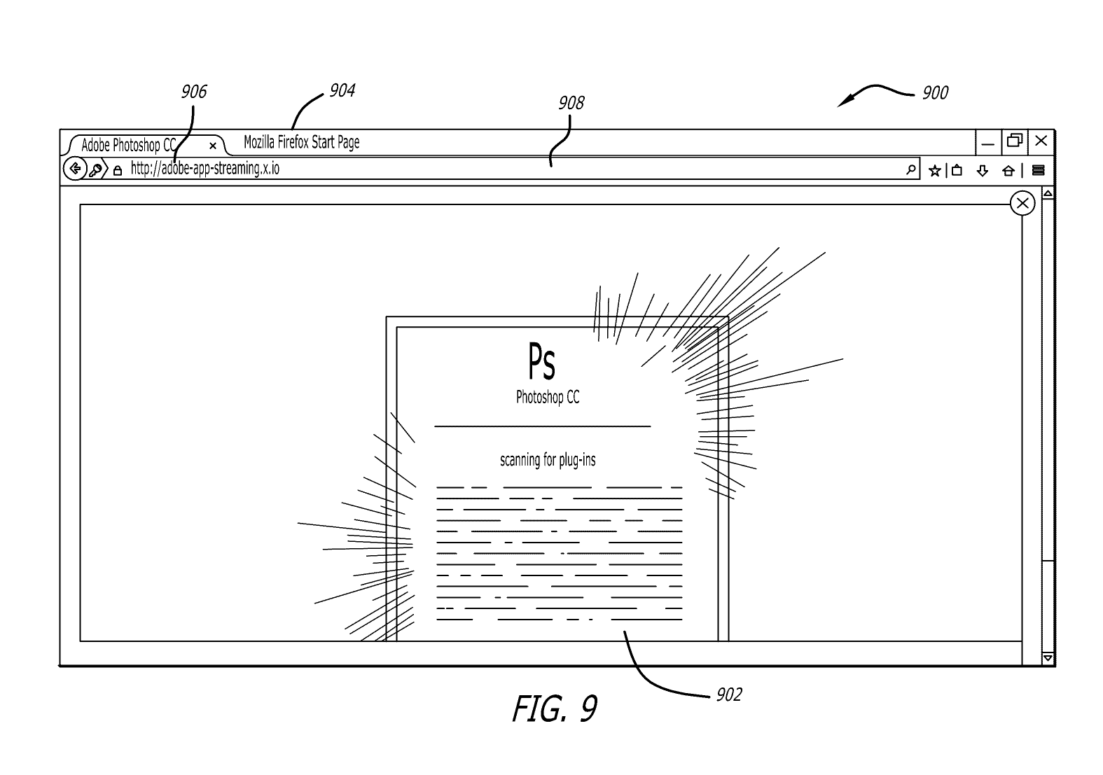

FIG. 9 is an illustration 900 that shows by the way of non-limiting example, an end user accessing the application 150 via the cloud server 104 in accordance with embodiments described herein. In this illustration, the application 150 being accessed is ADOBE PHOTOSHOP. The link information 906 in the address bar 908 of the web browser 904 can be indicative of the particular application being accessed. A splash screen 902 of the application 150 is shown that gives application package details such as the version number, notices regarding the copyright or other intellectual property and the like. The cloud server 104 executes a particular package of ADOBE PHOTOSHOP and streams the output to the client device 112 via a secure connection as indicated by the link 906. In this illustration, the client device 112 is a laptop which displays the output comprising the splash screen 902 in the browser window 904. It may be appreciated that other client devices such as but not limited to desktops, tablet devices, smartphones or wearable devices may also be used to access applications in accordance with embodiments described herein.

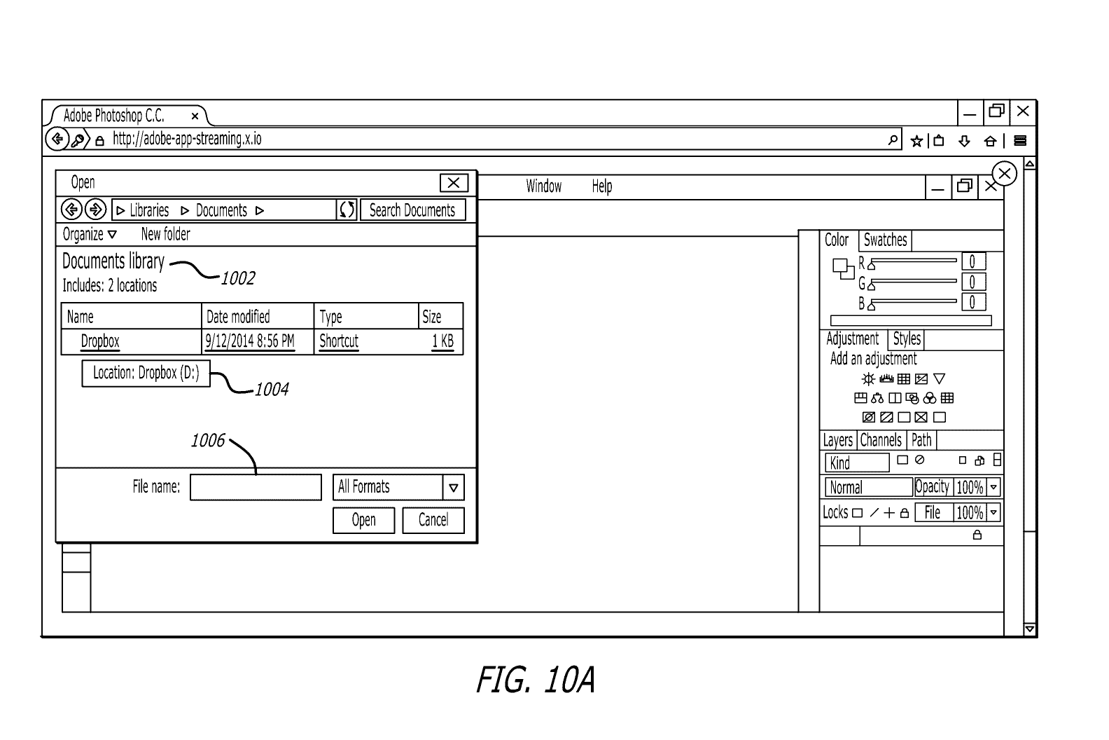

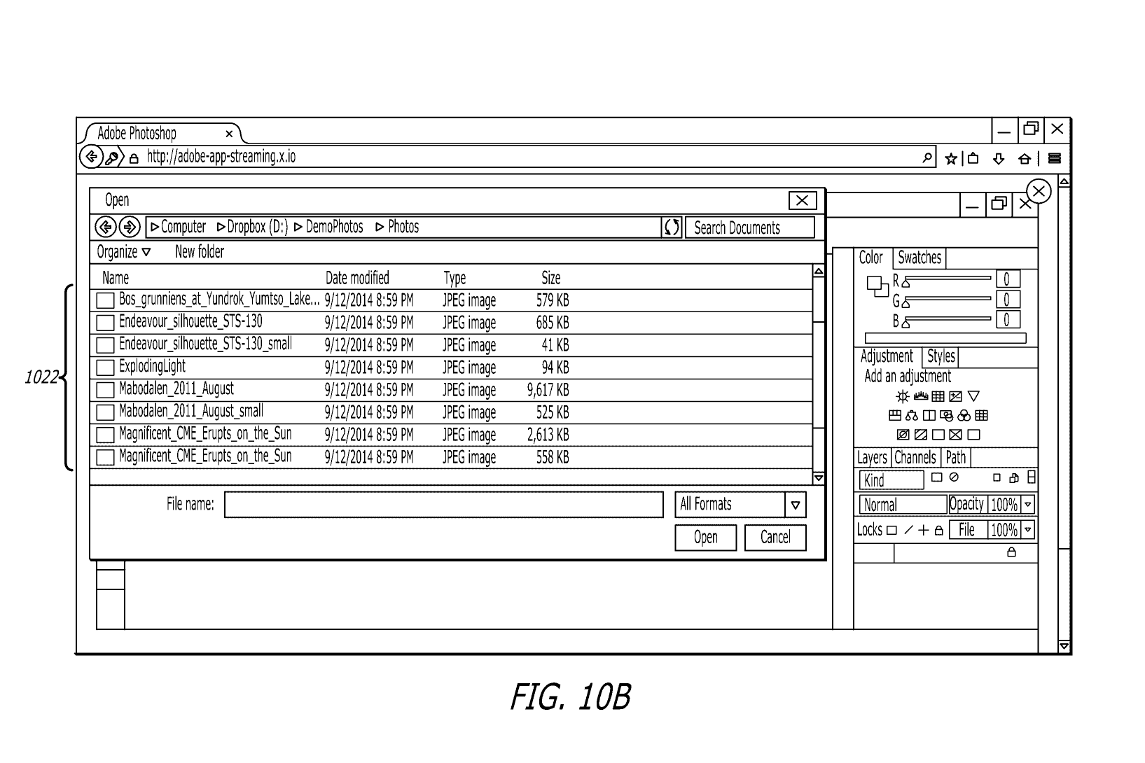

FIGS. 10 A and 10B show another non-limiting example of the end user accessing data files hosted by a third party storage service via the application 150 hosted by the cloud server 104 in accordance with embodiments described herein. As seen in FIG. 10A, the documents library 1002 includes a third-party DROPBOX storage location 1004. The end user may therefore, access files from the location via normal file interaction procedures, such as providing the file name to the file-open dialog box 1006. FIG. 10B illustrates the end user accessing image files 1022 from the DROPBOX location 1004.

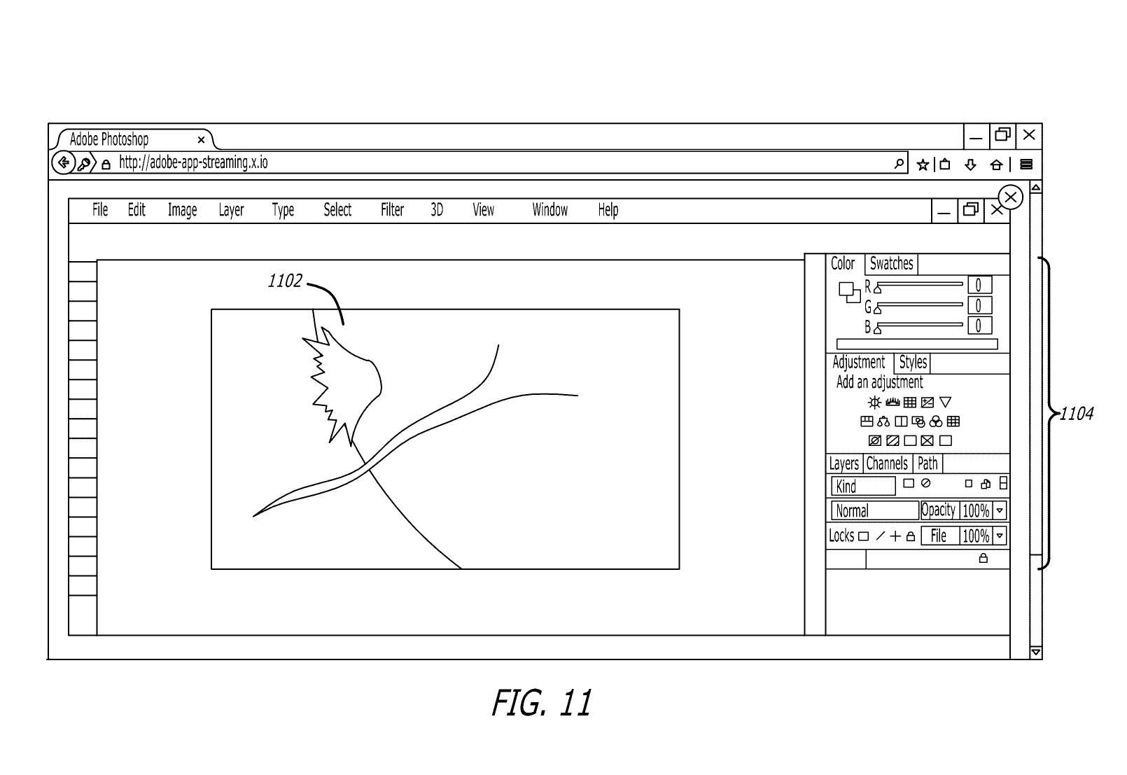

FIG. 11 shows a schematic diagram of an image file opened in an application executed by the cloud server wherein the image file is retrieved from a server associated with a third party data storage service. The browser window 904 displays an image file 1102 opened in ADOBE PHOTOSHOP from the DROPBOX location 1004. A panel 1104 comprising image editing tools is also opened. The end user may use the tools from the panel 1104 to edit the image file 1102. The edited image file may either be stored to one or more of a local memory of the client device 112 or the DROPBOX storage location. As illustrated in FIG. 11, the end user can access ADOBE PHOTOSHOP as if it were executing on the local drive of the client device 112. The end user is able to create, edit and delete image files even as the cloud server 104 executes the application 150. Thus, the remote access system 100 enables uploading users to cloudify applications thereby expanding their end-user accessibility.

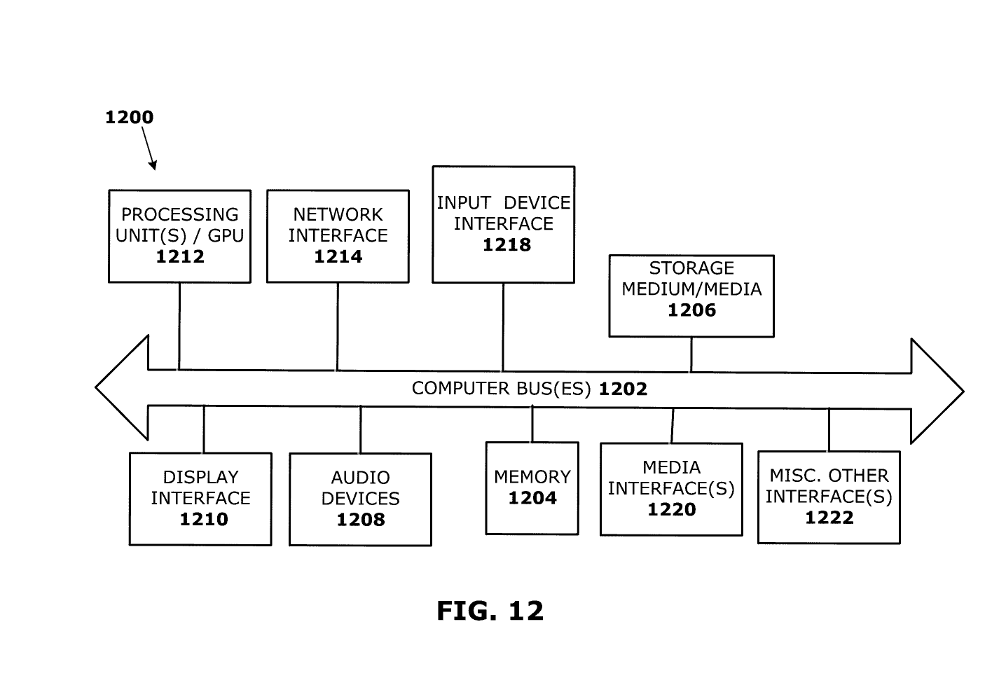

As shown in the example of FIG. 12, internal architecture of a computing device 1200 which can be employed as one or more of the remote server 102, the cloud server 104 or the client device 112 in accordance with embodiments described herein. The computing device 1200 includes one or more processing units (also referred to herein as CPUs) 1212, which interface with at least one computer bus 1202. Also interfacing with computer bus 1202 are persistent storage medium/media 1206, network interface 1214, memory 1204, e.g., random access memory (RAM), run-time transient memory, read only memory (ROM), etc., media disk drive interface 1220 which is an interface for a drive that can read and/or write to media including removable media such as floppy, CD-ROM, DVD, etc., media, display interface 1210 as interface for a monitor or other display device, input device interface 1218 which can include one or more of an interface for a keyboard or a pointing device such as but not limited to a mouse, and miscellaneous other interfaces 1222 not shown individually, such as parallel and serial port interfaces, a universal serial bus (USB) interface, and the like.

Memory 1204 interfaces with computer bus 1202 so as to provide information stored in memory 1204 to CPU 1212 during execution of software programs such as an operating system, application programs, device drivers, and software modules that comprise program code or logic, and/or instructions for computer-executable process steps, incorporating functionality described herein, e.g., one or more of process flows described herein. CPU 1212 first loads instructions for the computer-executable process steps or logic from storage, e.g., memory 1204, storage medium/media 1206, removable media drive, and/or other storage device. CPU 1212 can then execute the stored process steps in order to execute the loaded computer-executable process steps. Stored data, e.g., data stored by a storage device, can be accessed by CPU 1212 during the execution of computer-executable process steps.

Persistent storage medium/media 1206 are computer readable storage medium(s) that can be used to store software and data, e.g., an operating system and one or more application programs. Persistent storage medium/media 1206 can also be used to store device drivers, such as one or more of a digital camera driver, monitor driver, printer driver, scanner driver, or other device drivers, web pages, content files, metadata, playlists and other files. Persistent storage medium/media 1206 can further include program modules/program logic in accordance with embodiments described herein and data files used to implement one or more embodiments of the present disclosure.

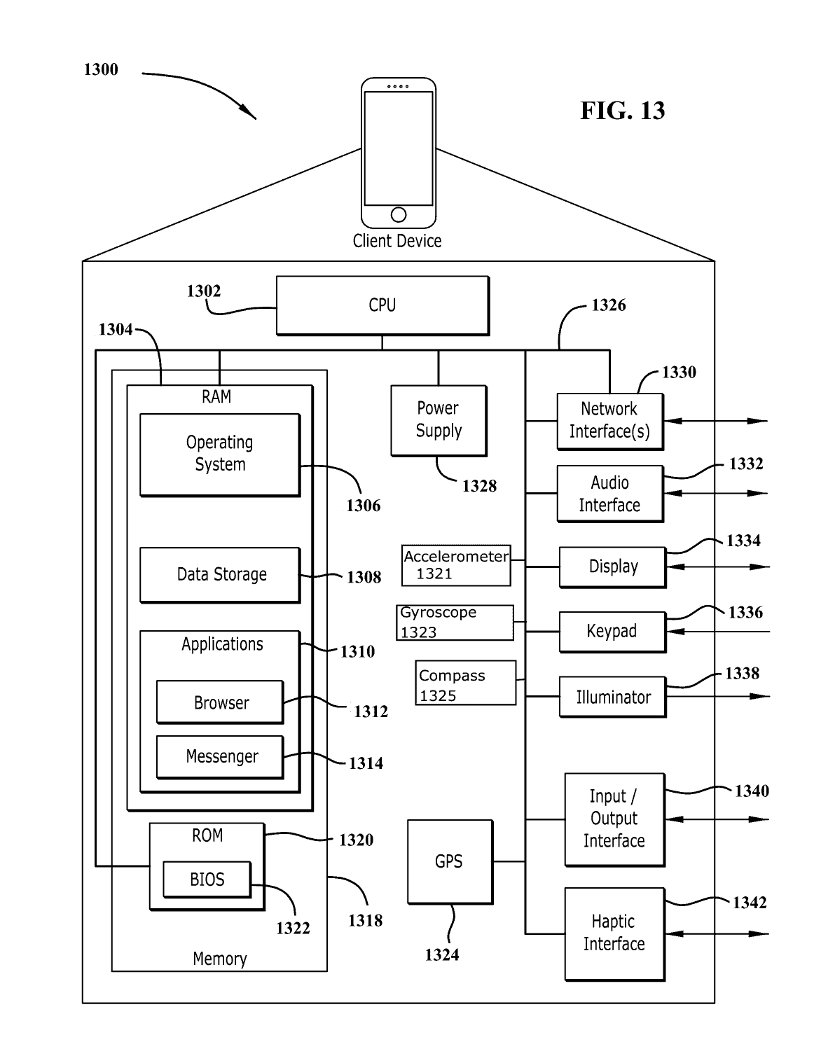

FIG. 13 is a schematic diagram illustrating a client device implementation of a computing device in accordance with embodiments of the present disclosure. A client device 1300 may include a computing device capable of sending or receiving signals, such as via a wired or a wireless network, and capable of running application software or “apps” 1310. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

A client device may vary in terms of capabilities or features. The client device can include standard components such as a CPU 1302, power supply 1328, a memory 1318, ROM 1320, BIOS 1322, network interface(s) 1330, audio interface 1332, display 1334, keypad 1336, illuminator 1338, I/O interface 1340 interconnected via circuitry 1326. Claimed subject matter is intended to cover a wide range of potential variations. For example, the keypad 1336 of a cell phone may include a numeric keypad or a display 1334 of limited functionality, such as a monochrome liquid crystal display (LCD) for displaying text. In contrast, however, as another example, a web-enabled client device 1300 may include one or more physical or virtual keyboards 1336, mass storage, one or more accelerometers 1321, one or more gyroscopes 1323 and a compass 1325 global positioning system (GPS) 1324 or other location identifying type capability, Haptic interface 1342, or a display with a high degree of functionality, such as a touch-sensitive color 2D or 3D display, for example. The memory 1318 can include Random Access Memory 1304 including an area for data storage 1308.

A client device 1300 may include or may execute a variety of operating systems 1306, including a personal computer operating system, such as a Windows, iOS or Linux, or a mobile operating system, such as iOS, Android, or Windows Mobile, or the like. A client device 1300 may include or may execute a variety of possible applications 1313, such as a client software application 1314 enabling communication with other devices, such as communicating one or more messages such as via email, short message service (SMS), or multimedia message service (MMS), including via a network, such as a social network, including, for example, Facebook, LinkedIn, Twitter, Flickr, or Google+, to provide only a few possible examples. A client device 1300 may also include or execute an application to communicate content, such as, for example, textual content, multimedia content, or the like. A client device 1300 may also include or execute an application to perform a variety of possible tasks, such as browsing 1312, searching, playing various forms of content, including locally stored or streamed content, such as, video, or games (such as fantasy sports leagues). The foregoing is provided to illustrate that claimed subject matter is intended to include a wide range of possible features or capabilities.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a system or module is a software, hardware, or firmware (or combinations thereof), program logic, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1) A method comprising:
receiving, by a processor, application files of a software application provided by an uploading user;
generating from the received application files, by the processor, an application package for distribution via a plurality of cloud servers, the application package comprises a self-sustaining executable file of the software application configured for execution in a virtual environment so that no changes are stored on an apparatus executing the application package when an end user exits an instance of the software application executed from the application package;
providing, by the processor, an application identifier to the uploading user, the application identifier is configured for enabling end user access to the software application via a user interface when included into code of the user interface;
receiving, by the processor, a request for access to the software application from an end user;
selecting, by the processor, one of the plurality of cloud servers to service the access request; and
transmitting, by the processor, the application package to a selected one of the plurality of cloud servers, in response to the access request from the end user.

2) The method of claim 1, further comprising:
configuring, by the processor, the application package to enable the end user's access to data files on a third party cloud storage server.

3) The method of claim 2 wherein at least a subset of the user data files are stored on the third-party cloud storage server.

4) The method of claim 1 further comprising:
determining, by the processor, attributes of the access request received from the end user.

5) The method of claim 4, selecting one of the plurality of cloud servers further comprising:
selecting, by the processor, one of the plurality of cloud servers to service the access request based on the attributes.

6) The method of claim 1, the access request comprises the application identifier.

7) The method of claim 1, further comprising:
selecting, by the processor, the application package from a plurality of application packages based on the application identifier in the access request.

8) The method of claim 4, the attributes comprise geographic location of the client device and nature of the network employed by the client device for transmitting the access request.

9) The method of claim 1, generating the application package further comprises:
executing, by the processor, a clean server instance of a remote server;
installing, by the processor, the application on the clean server instance; and
recording, by the processor, changes made to the clean server instance upon the installation of the application.

10) The method of claim 7 further comprising:
configuring, by the processor, the changes into the self-sustaining executable file; and
virtualizing, by the processor, the self-sustaining executable file for the generation the software package.

11) The method of claim 1 wherein the plurality of servers are located across the globe in geographically disparate regions.

12) The method of claim 1, the uploading user is a developer of the application.

13) An apparatus comprising:
a processor; and
non-transitory storage medium comprising programming logic for execution by the processor, the programming logic comprising:
file receiving logic, executed by the processor, for receiving application files of a software application provided by an uploading user;
generating logic, executed by the processor, for generating from the received application files, an application package for distribution via a plurality of cloud servers, the application package comprises a self-sustaining executable file of the software application configured for execution in a virtual environment so that no changes are stored on an apparatus executing the application package when the end user exits the software application;
providing logic, executed by the processor, for providing an application identifier to the uploading user, the application identifier is configured for enabling end user access to the software application via a user interface when included into code of the user interface;
request receiving logic, executed by the processor, for receiving a request for access to the software application from an end user;
server selecting logic, executed by the processor, for selecting one of the plurality of cloud servers to service the access request; and
transmitting logic, executed by the processor, for transmitting the application package to a selected one of the plurality of cloud servers, in response to the access request from the end user.

14) The apparatus of claim 13, further comprising:
configuring logic, executed by the processor, for configuring the application package to enable the end user's access to data files on a third party cloud storage.

15) The apparatus of claim 13 further comprising:
determining logic, executed by the processor, for determining attributes of the access request received from the end user.

16) The apparatus of claim 15, the server selecting logic further comprising:
logic executed by the processor, for selecting one of the plurality of cloud servers to service the access request based on the attributes.

17) The apparatus of claim 13, the access request comprises the application identifier.

18) The apparatus of claim 17, further comprising:
application selecting logic, executed by the processor, for selecting the application package from a plurality of application packages based on the application identifier in the access request.

19) The apparatus of claim 18, the generating logic further comprises:
clean server executing logic, executed by the processor, for executing a clean server instance of a remote server;
installing logic, executed by the processor, for installing the application on the clean server instance; and
recording logic, executed by the processor, for recording changes made to the clean server instance upon the installation of the application.

20) The apparatus of claim 19, the generating logic further comprising:
change configuring logic, executed by the processor, for configuring the changes into the self-sustaining executable file; and
virtualizing logic, executed by the processor, for virtualizing the self-sustaining executable file for the generation the software package.

21) Non-transitory computer readable storage medium comprising instructions for:
receiving application files of a software application provided by an uploading user;
generating from the received application files, an application package for distribution via a plurality of cloud servers, the application package comprises a self-sustaining executable file of the software application configured for execution in a virtual environment so that no changes are stored on an apparatus executing the application package when the end user exits the software application;
providing an application identifier to the uploading user, the application identifier is configured for enabling end user access to the software application via a user interface when included into code of the user interface;
receiving a request for access to the software application from an end user;
selecting one of the plurality of cloud servers to service the access request; and
transmitting the application package to a selected one of the plurality of cloud servers, in response to the access request from the end user.

22) The non-transitory computer readable storage medium of claim 21 further comprising instructions for:
configuring the application package to enable the end user's access to data files on a third party cloud storage.

23) The non-transitory computer readable storage medium of claim 21 further comprising instructions for:
determining attributes of the access request received from the end user.

24) The non-transitory computer readable storage medium of claim 23, the instructions for selecting one of the plurality of cloud servers comprise further instructions for:
selecting one of the plurality of cloud servers to service the access request based on the attributes.

25) The non-transitory computer readable storage medium of claim 21 further comprising instructions for:
selecting, by the processor, the application package from a plurality of application packages based on the application identifier determined from the access request.
